(19) United States
(12) Patent Application Publication
(10) Pub. No.: US 2017/0147499 A1
(43) Pub. Date: May 25, 2017

(54) Multi-Level Logical to Physical Address Mapping Using Distributed Processors in Non-Volatile Storage Device

(71) Applicant: SanDisk Technologies LLC, Plano, TX (US)

(72) Inventors: Vidyabhushan Mohan, San Jose, CA (US); Jack Edward Frayer, Boulder Creek, CA (US)

(21) Appl. No.: 15/179,786

(22) Filed: Jun. 10, 2016

Related U.S. Application Data
(60) Provisional application No. 62/260,150, filed on Nov. 25, 2015.

(51) Int. Cl. G06F 12/10; G06F 3/06

(52) U.S. Cl. CPC G06F 12/10; G06F 3/0604; G06F 3/0616; G06F 3/0631; G06F 3/0688; G06F 2212/7201

(57) ABSTRACT

In a method to provide scalable and distributed address mapping in a storage device, a host command that specifies an operation to be performed and a logical address corresponding to a portion of memory within the storage device is received or accessed. A storage controller of the storage device maps the specified logical address to a first subset of a physical address, using a first address translation table, and identifies an NVM module of the plurality of NVM modules, in accordance with the first subset of a physical address. The method further includes, at the identified NVM module, mapping the specified logical address to a second subset of the physical address, using a second address translation table, identifying the portion of non-volatile memory within the identified NVM module corresponding to the specified logical address, and executing the specified operation on the portion of memory in the identified NVM module.

### RELATED APPLICATIONS

This application claims priority to U.S. Provisional Patent Application No. 62/260,150, filed Nov. 25, 2015, which is hereby incorporated by reference in its entirety.

### TECHNICAL FIELD

The disclosed embodiments relate generally to memory systems, and in particular, to enable scalable and distributed address mapping of storage devices (e.g., memory devices).

### BACKGROUND

Semiconductor memory devices, including flash memory, typically utilize memory cells to store data as an electrical value, such as an electrical charge or voltage. A flash memory cell, for example, includes a single transistor with a floating gate that is used to store a charge representative of a data value. Flash memory is a non-volatile data storage device that can be electrically erased and reprogrammed. More generally, non-volatile memory (e.g., flash memory, as well as other types of non-volatile memory implemented using any of a variety of technologies) retains stored information even when not powered, as opposed to volatile memory, which requires power to maintain the stored information.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to enable scalable and distributed address mapping of storage devices.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a block diagram illustrating an implementation of a data storage system, in accordance with some embodiments.

FIG. 2A is a block diagram illustrating an implementation of a management module of a storage device controller, in accordance with some embodiments.

FIG. 2B is a block diagram illustrating an implementation of a non-volatile memory module, in accordance with some embodiments.

FIGS. 3A-3B illustrate various logical to physical memory address translation tables, in accordance with some embodiments.

FIGS. 4A-4D illustrate a flowchart representation of a method of enabling scalable and distributed address mapping of non-volatile memory devices in a storage device, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The various implementations described herein include systems, methods and/or devices used to enable larger amounts of non-volatile memory to be provided in a storage device.

As the electronics industry progresses, the memory storage needs for electronic devices ranging from smart phones to server systems are rapidly growing. For example, as enterprise applications mature, the capacity of storage devices required for these applications have dramatically increased. As the capacity has increased, correspondingly, the number of non-volatile memory chips inside the storage devices has also increased. As a result of the number of memory chips increasing, the centralized hardware resources inside these storage devices are under higher demand to manage the reliability of the memory.

In order to effectively manage the reliability of non-volatile memories in storage devices, some implementations described herein use scalable techniques of managing reliability data for non-volatile memory (NVM) modules, where each non-volatile memory module includes one or more memory die and typically includes multiple memory die. In some implementations, a storage device includes one or more non-volatile memory modules. For example, as memory storage needs increase, the memory capacity of a single storage device can be increased by adding one or more additional non-volatile memory modules.

In some implementations, each non-volatile memory module in the storage device includes a non-volatile memory (NVM) module controller. As an example of one of its functions, a NVM module controller manages the address mapping of the memory chips within a particular NVM module and thereby reduces the work needed to be done by a storage controller of the storage device. Thus, in some implementations, by freeing up the central resources in the storage controller from reliability management, the storage controller can provide higher performance for other operations in the storage device, and can therefore manage a greater amount of non-volatile memory than if the storage controller were handling all address mapping and other non-volatile memory management tasks for the storage device.

(A1) More specifically, some implementations include a method of scalable and distributed memory addressing in a storage device (e.g., a non-volatile memory device) that includes a plurality of non-volatile memory modules. In some implementations, the method includes receiving or accessing (e.g., in a command queue) a host command, the host command specifying an operation to be performed and a logical address corresponding to a portion of non-volatile memory within the storage device. The method also includes, at a storage controller for the storage memory device, mapping a portion of the specified logical address to a partial physical address, comprising a portion of a physical address, using a first address translation table, and identifying a coarse memory portion within the plurality of NVM modules, in accordance with the partial physical address. The method further includes, at a memory module controller for the coarse memory portion, identifying a fine memory portion within the coarse memory portion by mapping the specified logical address to the physical address, using a second address translation table, wherein the fine memory portion corresponds to the physical address, and executing the respective operation on the fine memory portion.

(A2) In some embodiments of the method of Al, the host command is a write command to write data, and executing the respective operation on the fine memory portion includes, at the memory module controller for the coarse memory portion, allocating at least one fine memory portion within the coarse memory portion, writing the data to the at least one fine memory portion, and updating a portion of the second address translation table corresponding to the physical address with the specified logical address and a valid flag value.

(A3) In some embodiments of the method of A1 or A2, the host command requests an unmap operation and specifies a logical address to be unmapped, and executing the respective operation on the fine memory portion comprises, at the memory module controller for the coarse memory portion, updating a portion of the second address translation table corresponding to the specified logical address with an invalid flag value.

(A4) In some embodiments of the method of any of A1-A3, the second address table is stored in non-volatile memory controlled by the memory module controller for the coarse memory portion.

(A5) In some embodiments of the method of any of A1-A4, the second address table is stored in non-volatile memory using a single-layer cell (SLC) mode of operation.

(A6) In some embodiments of the method of any of A1-A5, the partial physical address includes a first predefined number of most significant bits of the physical address and the portion of the specified logical address includes a second predefined number of most significant bits of the specified logical address.

(A7) In some embodiments of the method of A6, the number of bits of the specified logical address is M, the second predefined number of most significant bits of the specified logical address is N, and the size of a logical address space portion mapped by each entry of the first address translation table is 2^{(M-N)} times the size of a physical memory portion mapped by each entry of the second address translation table.

(A8) In some embodiments of the method of any of A1-A7, the coarse memory portion is a memory channel, a multi-die memory module, a memory die, a plane of a memory die, or a block.

(A9) In some embodiments of the method of any of A1-A8, the method further includes, at the memory module controller for the coarse memory portion, storing wear level information for a plurality of portions of the coarse memory portion, and performing wear leveling using the stored wear level information for the plurality of portions of the coarse memory portion.

(A10) In some embodiments of the method of any of A1-A9, the memory module controller for the coarse memory portion is the memory module controller for a particular NVM module of the plurality of NVM modules, the method further includes, at the memory module controller for the particular NVM module, (a) in conjunction with a write operation performed by the storage device, encoding data with error correction information and stores the encoded data in non-volatile memory of the particular NVM module, and (b) in conjunction with a read operation performed by the storage device, decoding data stored in said non-volatile memory of the particular NVM module to generate decoded data.

(A11) In some embodiments of the method of any of A1-A10, the second address translation table is indexed by physical addresses and includes entries that map respective physical addresses, in a predefined range of physical addresses, to logical addresses.

(Al2) In some embodiments of the method of A11, the second address translation table further includes a tree structure indexed by logical addresses for locating entries in the second translation table.

(A13) In another aspect, any of the methods described above are performed by a storage device including (1) an interface for coupling the storage device to a host system, (2) a plurality of NVM modules, each NVM module including two or more non-volatile memory devices, and (3) a storage controller having one or more hardware processors. The storage controller is configured to: (A) receive or access (e.g., in a command queue) a host command, the host command specifying a respective operation to be performed and a logical address corresponding to a portion of non-volatile memory within the storage device, and (B) map a portion of the specified logical address to a partial physical address, comprising a portion of a physical address, using a first address translation table, and (4) a memory module controller for the identified coarse memory portion, the memory module controller having one or more hardware processors. The memory module controller is configured to: (A) identify a fine memory portion within the coarse memory portion by mapping the specified logical address to the physical address, using a second address translation table, wherein the fine memory portion corresponds to the physical address, and (B) execute the respective operation on the fine memory portion.

(A14) In some embodiments, the storage device of A13 is configured to perform any of the methods described above.

(A15) In some embodiments of the storage device of any of A13-A14, the storage controller includes a first map module, for execution by the one or more hardware processors of the storage controller, to map the portion of the specified logical address to the partial physical address using the first address translation table, and the memory module controller includes a second map module, for execution by the one or more hardware processors of the memory module controller, to map the specified logical address to the physical address, using the second address translation table.

(A16) In yet another aspect, any of the methods described above are performed by a storage device. In some embodiments, the storage device includes a plurality of NVM modules, means for coupling the storage device to a host system, and means for controlling operation of the storage device. The means for controlling operation of the storage device includes means for receiving a host command specifying a respective operation to be performed at a logical address specified by the host command, the specified logical address corresponding to a portion of non-volatile memory within the storage device; and means for mapping a portion of the specified logical address to a partial physical address, comprising a portion of a physical address, using a first address translation table; wherein a coarse memory portion within a respective NVM module, of the plurality of NVM modules, corresponds to the partial physical address. The storage device further includes means for controlling operation of the respective NVM module, which includes means for identifying a fine memory portion within the coarse memory portion by mapping the specified logical address to the physical address, using a second address translation table, wherein the fine memory portion corresponds to the physical address; and means for executing the respective operation on the fine memory portion.

(A17) In some embodiments of the storage device of A16, the storage device is configured to perform any of the methods described above.

In yet another aspect, a non-transitory computer readable storage medium stores one or more programs for execution by one or more processors of a storage device, the one or more programs including instructions for performing any of the methods described above.

In some embodiments, the storage device includes a plurality of controllers, and the non-transitory computer readable storage medium includes a non-transitory computer readable storage medium for each controller of the plurality of controllers, each having one or more programs including instructions for performing a respective portion of any of the methods described above.

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

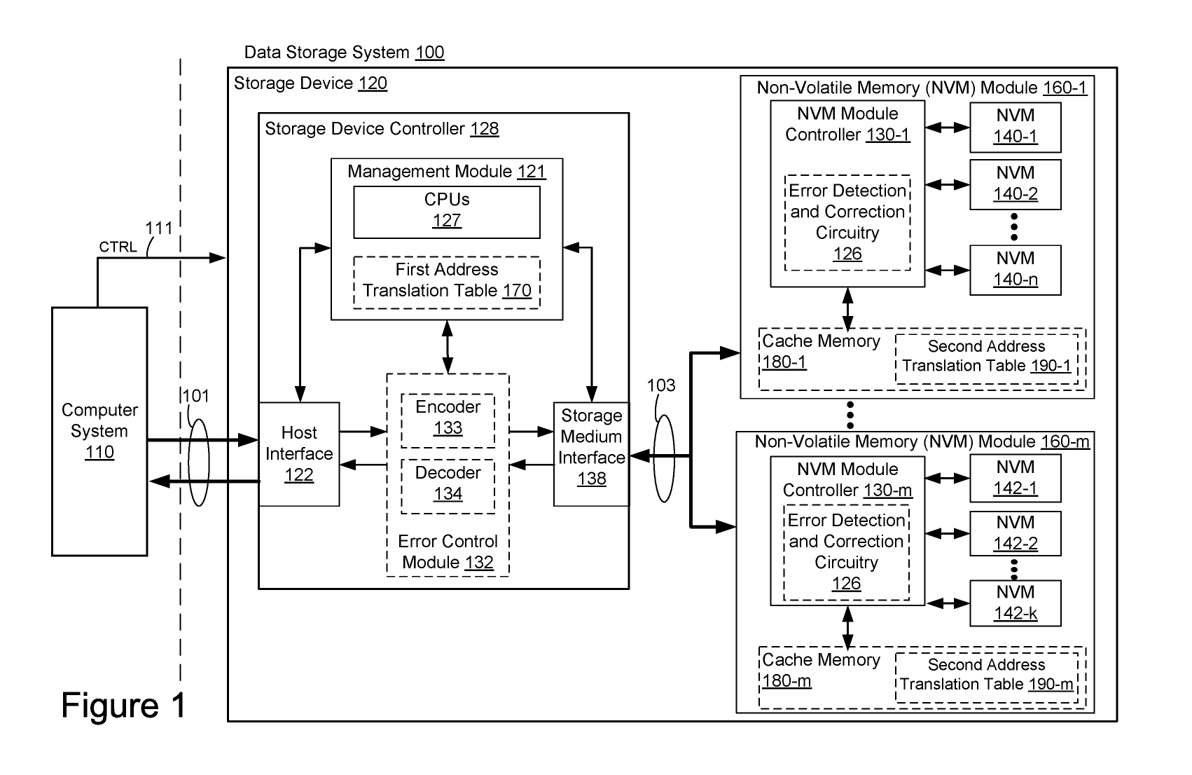

FIG. 1 is a block diagram illustrating an implementation of a data storage system 100, in accordance with some embodiments. While some example features are illustrated, various other features have not been illustrated for the sake of brevity and so as not to obscure more pertinent aspects of the example implementations disclosed herein. To that end, as a non-limiting example, data storage system 100 includes storage device 120, which includes storage device controller 128, and one or more NVM modules (e.g., NVM modules(s) 160). The storage device 120 is used in conjunction with or includes computer system 110 (e.g., a host system or a host computer).

Computer system 110 is coupled to storage device 120 through data connections 101. However, in some implementations computer system 110 includes storage device 120 as a component and/or sub-system. Computer system 110 may be any suitable computer device, such as a personal computer, a workstation, a computer server, or any other computing device. Computer system 110 is sometimes called a host or host system. In some implementations, computer system 110 includes one or more processors, one or more types of memory, optionally includes a display and/or other user interface components such as a keyboard, a touch screen display, a mouse, a track-pad, a digital camera and/or any number of supplemental devices to add functionality. Further, in some implementations, computer system 110 sends one or more host commands (e.g., read commands and/or write commands) on control line 111 to storage device 120. In some implementations, computer system 110 is a server system, such as a server system in a data center, and does not have a display and other user interface components.

Connected to computer system 110 through data connections 101, in some implementations, storage device controller 128 includes host interface 122, management module 121, error control module 132, and storage medium interface 138. Storage device controller 128 may include various additional features that have not been illustrated for the sake of brevity and so as not to obscure more pertinent features of the example implementations disclosed herein, and that a different arrangement of features may be possible.

Host interface 122 provides an interface to computer system 110 through data connections 101. Similarly, storage medium interface 138 provides an interface to storage medium 161 though connections 103. Connections 103 are sometimes called data connections, but typically convey commands in addition to data, and optionally convey metadata, error correction information and/or other information in addition to data values to be stored in NVM modules 160 and data values read from NVM modules 160. In some implementations, storage medium interface 138 includes read and write circuitry, including circuitry capable of providing reading signals to NVM modules 160 (e.g., reading threshold voltages for NAND-type flash memory). In some embodiments, connections 101 and connections 103 are implemented as a communication media over which commands and data are communicated, using a protocol such as DDR3, SCSI, SATA, SAS, or the like.

In some implementations, management module 121 includes one or more processing units (CPUs, also sometimes called processors) 127 configured to execute instructions in one or more programs (e.g., in management module 121). In some implementations, the one or more CPUs 127 are shared by one or more components within, and in some cases, beyond the function of storage device controller 128. Management module 121 is coupled to host interface 122, error control module 132, and storage medium interface 138 in order to coordinate the operation of these components. In some embodiments, storage device controller 128 also includes a first address translation table 170, sometimes herein called a top-level address translation table or first level address translation table. In some embodiments, first address translation table 170 is a logical to physical address table that maps a portion of logical address (e.g., the portion of a logical address without the two least significant bits) to a partial physical address (e.g., the first 9 bits of a 32-bit or 48-bit physical address) for identifying a coarse memory portion within the NVM modules 160. In some embodiments, the partial physical address, stored in first address translation table 170, includes a predefined number of most significant bits (e.g., 9 bits) of a respective physical address in one of the NVM devices (e.g., NVM devices 140, 142).

Error control module 132 is coupled to host interface 122, management module 121, and storage medium interface 138. Error control module 132 is provided to limit the number of uncorrectable errors inadvertently introduced into data. In some embodiments, error control module 132 includes an encoder 133 and a decoder 134. Encoder 133 encodes data by applying an error control code to produce a codeword, which is subsequently stored in storage medium 161. In some embodiments, when the encoded data (e.g., one or more codewords) is read from NVM modules 160, decoder 134 applies a decoding process to the encoded data to recover the data, and to correct errors in the recovered data within the error correcting capability of the error control code. For the sake of brevity, an exhaustive description of the various types of encoding and decoding algorithms generally available and known to those skilled in the art is not provided herein.

In some embodiments, each NVM module 160 coupled to storage device controller 128 through connections 103 includes an NVM module controller 130, or alternatively one or more NVM module controllers, and one or more NVM devices 140, 142 (e.g., flash memory die). In some embodiments, each NVM module controller 130 includes one or more processing units (also sometimes called CPUs, processors, hardware processors, microprocessors or microcontrollers) configured to execute instructions in one or more programs (e.g., one or more programs stored in controller memory of the NVM module controller). In some embodiments, NVM devices 140, 142 are coupled to NVM module controllers 130 through connections that convey commands in addition to data, and optionally convey metadata, error correction information and/or other information in addition to data values to be stored in NVM devices 140, 142 and data values read from NVM devices 140, 142.

In some embodiments, storage device 120, NVM modules 160, and/or NVM devices 140, 142 are configured for enterprise storage suitable for applications such as cloud computing, or for caching data stored (or to be stored) in secondary storage, such as hard disk drives. Additionally and/or alternatively, storage device 120, NVM modules 160, and/or NVM devices 140, 142 are configured for relatively smaller-scale applications such as personal flash drives or hard-disk replacements for personal, laptop and tablet computers. While in some embodiments NVM devices 140, 142 are flash memory devices and NVM module controllers 160 are flash memory controllers or solid state storage controllers, in other embodiments storage device 120 may include other types of non-volatile memory devices and corresponding controllers.

In some embodiments, each NVM module controller 130 includes error detection and correction circuitry 126. In these embodiments, error detection and correction circuitry 126 is used to encode data being written to NVM devices 140, 142, and decode data being read from NVM device 140, 142, and detect and correct data errors during data decoding. Optionally, in such embodiments storage device controller 128 does not include error control module 132, because the error control functions that would otherwise be performed by are error control module 132 are instead handled by error detection and correction circuitry 126 in the NVM modules 160. In some embodiments, error detection and correction circuitry 126 includes one or more hardware processing units. In some embodiments, error detection and correction circuitry 126 is implemented using a hardware state machine, and in some embodiments, error detection and correction circuitry 126 is implemented in an application-specific integrated circuit (ASIC). In some embodiments, error detection and correction circuitry 126 uses one or more error detection and/or correction schemes, such as Hamming, Reed-Solomon (RS), Bose Chaudhuri Hocquenghem (BCH), and low-density parity-check (LDPC), or the like.

Though not shown in FIG. 1, error detection and correction circuitry 126 typically includes an encoder and decoder. In some embodiments, error detection and correction circuitry 126 is coupled to NVM devices 140, 142, and storage device controller 128, in order to receive raw data from the storage controller to encode, and to receive encoded data (e.g., one or more codewords) from the NVM devices to decode. Using error detection and correction circuitry 126 in each NVM module controller 130, data encoding and decoding is performed locally by each NVM module controller 130, and thus data encoding and decoding is decentralized and the scalability of storage system 100 is improved.

In some implementations, storage device 120 includes a single NVM device while in other implementations storage device 120 includes a plurality of NVM devices. In some implementations, NVM devices 140, 142 include NAND-type flash memory or NOR-type flash memory. Further, in some implementations, NVM module controller 130 comprises a solid-state drive (SSD) controller.

In some embodiments, NVM devices 140, 142 are flash memory chips or die, sometimes herein called flash memory devices. Each NVM device includes a number of addressable and individually selectable blocks. In some implementations, the individually selectable blocks (sometimes called erase blocks) are the minimum size erasable units in a flash memory device. In other words, each block contains the minimum number of memory cells that can be erased simultaneously. Each block is usually further divided into a plurality of pages and/or word lines, for example, 64 pages, 128 pages, 256 pages or another suitable number of pages. Each page or word line is typically an instance of the smallest individually accessible (readable) portion in a block. In some implementations (e.g., using some types of flash memory), the smallest individually accessible unit of a data set, however, is a sector, which is a subunit of a page. That is, a block includes a plurality of pages, each page contains a plurality of sectors, and each sector is the minimum unit of data for reading data from the flash memory device.

In some embodiments, the blocks in each NVM device are grouped into a plurality of zones or planes. Each zone or plane can be independently managed to some extent, which increases the degree of parallelism for parallel operations, such as reading and writing data to NVM devices 140, 142.

In some embodiments, if data is written to a storage medium in pages, but the storage medium is erased in blocks, pages in the storage medium may contain invalid (e.g., stale) data, but those pages cannot be overwritten until the whole block containing those pages is erased. In order to write to the pages with invalid data, the pages (if any) with valid data in that block are read and re-written to a new block and the old block is erased (or put on a queue for erasing). This process is called garbage collection. After garbage collection, the new block contains the pages with valid data and may have free pages that are available for new data to be written, and the old block can be erased so as to be available for new data to be written.

A phenomenon related to garbage collection is write amplification. Write amplification is a phenomenon where the actual amount of physical data written to a storage medium (e.g., NVM devices 140, 142 in storage device 120) is a multiple of the logical amount of data written by a host (e.g., computer system 110, sometimes called a host) to the storage medium. As discussed above, when a block of storage medium must be erased before it can be re-written, the garbage collection process to perform these operations results in re-writing data one or more times. This multiplying effect increases the number of writes required over the life of a storage medium, which shortens the time it can reliably operate. The formula to calculate the write amplification of a storage system is given by equation:

$$\frac{amount of data written to a storage medium}{amount of data written by a host}$$

One of the goals of any flash memory based data storage system architecture is to reduce write amplification as much as possible so that available endurance is used to meet storage medium reliability and warranty specifications. Higher system endurance also results in lower cost as the storage system may need less over-provisioning. By reducing write amplification, the endurance of the storage medium is increased and the overall cost of the storage system is decreased. Generally, garbage collection is performed on erase blocks with the fewest number of valid pages for best performance and best write amplification.

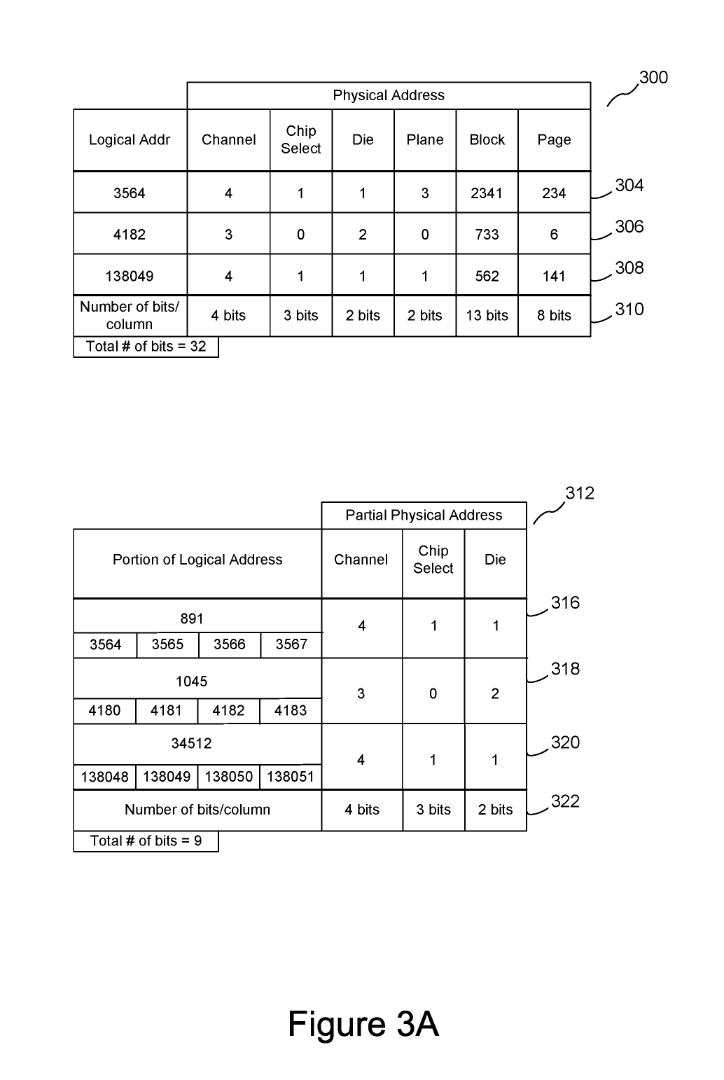

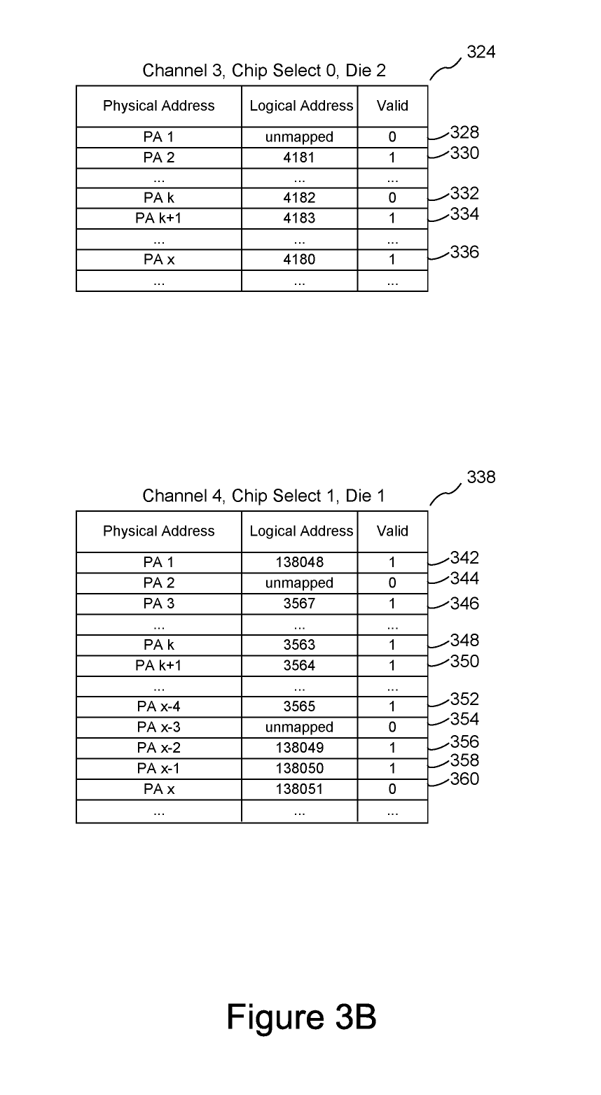

In some embodiments, storage device 120 translates logical addresses received in commands from computer system 110 into physical addresses using a two-level address translation mechanism, which is explained in more detail below with reference to FIGS. 3A and 3B. This two-level address translation or mapping scheme increases the size of the physical address space that can be included in a single storage device and enables a higher degree of scalability of the storage device 120 than would otherwise be possible. Storage device controller 128 uses a first address translation table 170 to translate a logical address into a partial physical address, which corresponds to a so-called coarse memory portion (e.g., a flash memory die) in NVM modules 160. Typically, each coarse memory portion is located in a single one of the NVM modules 160.

NVM modules 160 each store one or more second address translation tables 190, sometimes herein called lower-level address translation tables or second level address translation tables. For example, in some embodiments, each NVM module has a single second address translation table 190 for handling the mapping of logical addresses into physical address for all non-volatile memory in the NVM module. In some other embodiments, each NVM module has multiple second address translation tables 190, each of which is used to handle the mapping of logical addresses into physical address for one or more coarse memory portions of the non-volatile memory in the NVM module. Optionally, each NVM module 160 includes cache memory 180, which is used to store one or more second address translation tables 190, or a portion of a second address translation table 190, depending on the implementation.

In some embodiments, second address translation table 190 is indexed by physical addresses and includes entries that map respective physical addresses, in a predefined range of physical addresses (e.g., a range of physical addresses corresponding to a coarse memory portion), to logical addresses. In some such embodiments, the second address translation table 190 does not include the physical addresses, since the physical address associated with each entry of the second address translation table 190 corresponds to its position in the second address translation table 190. Furthermore, to facilitate searching the second address translation table 190 for a specified logical address, in some embodiments, second address translation table 190 further includes a tree structure (e.g., B-tree) indexed by logical addresses for locating entries in the second translation table 190.

In some embodiments, in addition to storing address mapping information, second address translation table 190 stores other information to facilitate memory operations, such as a valid flag value indicating whether the data stored at a particular physical address is valid. In some embodiments, second address translation table 190 stores wear leveling information to facilitate wear leveling. In some embodiments, the valid flag value for a fine memory portion is changed to “valid” during a write operation, and is changed from “valid” to “invalid” during an unmap operation. In some embodiments, second address translation table 190 is stored in content addressable memory. In some embodiments, second address translation table 190 is stored in a byte-addressable persistent memory that provides for faster read and/or write-access than other memories within NVM modules 160.

During a write operation, host interface 122 receives a write command, which includes data to be stored in NVM modules 160 from computer system 110. The received data, sometimes called write data, is encoded using encoder 133 of storage device controller 128 or using error detection and correction circuitry 126 of a respective NVM module controller 130, depending on the embodiment, to produce encoded data, typically in the form of one or more codewords. The resulting encoded data is stored in non-volatile memory of a particular NVM module 160.

During a read operation, host interface 122 receives a read command from computer system 110. In response, data read from non-volatile memory of a particular NVM module 160 is decoded using decoder 134 of storage device controller 128 or using error detection and correction circuitry 126 of a respective NVM module controller 130, depending on the embodiment, to produce decoded data. The resulting decoded data, sometimes called read data, is provided to computer system 110 in response to the read command, via host interface 122.

As explained above, a storage medium (e.g., NVM devices 140, 142) is divided into a number of addressable and individually selectable blocks and each block is optionally (but typically) further divided into a plurality of pages and/or word lines and/or sectors. While erasure of a storage medium is performed on a block basis, in many embodiments, reading and programming of the storage medium is performed on a smaller subunit of a block, such as a page or word line, having multiple memory cells (e.g., single-level cells or multi-level cells). In some embodiments, programming is performed on an entire page. In some embodiments, a multi-level cell (MLC) NAND flash typically has four possible states per cell, yielding two bits of information per cell. Further, in some embodiments, a MLC NAND has two page types: (1) a lower page (sometimes called fast page), and (2) an upper page (sometimes called slow page). In some embodiments, a triple-level cell (TLC) NAND flash has eight possible states per cell, yielding three bits of information per cell. Although the description herein uses TLC, MLC, and SLC as examples, those skilled in the art will appreciate that the embodiments described herein may be extended to memory cells that have more than eight possible states per cell, yielding more than three bits of information per cell. In some embodiments, the encoding format of the storage media (e.g., TLC, MLC, or SLC and/or a chosen data redundancy mechanism) is a choice made (or implemented) when data is actually written to the storage media.

Flash memory devices (e.g., NVM 140, 142) utilize memory cells (e.g., SLC, MLC, and/or TLC) to store data as electrical values, such as electrical charges or voltages. Each flash memory cell typically includes a single transistor with a floating gate that is used to store a charge, which modifies the threshold voltage of the transistor (e.g., the voltage needed to turn the transistor on). The magnitude of the charge, and the corresponding threshold voltage the charge creates, is used to represent one or more data values. In some embodiments, during a read operation, a reading threshold voltage is applied to the control gate of the transistor and the resulting sensed current or voltage is mapped to a data value.

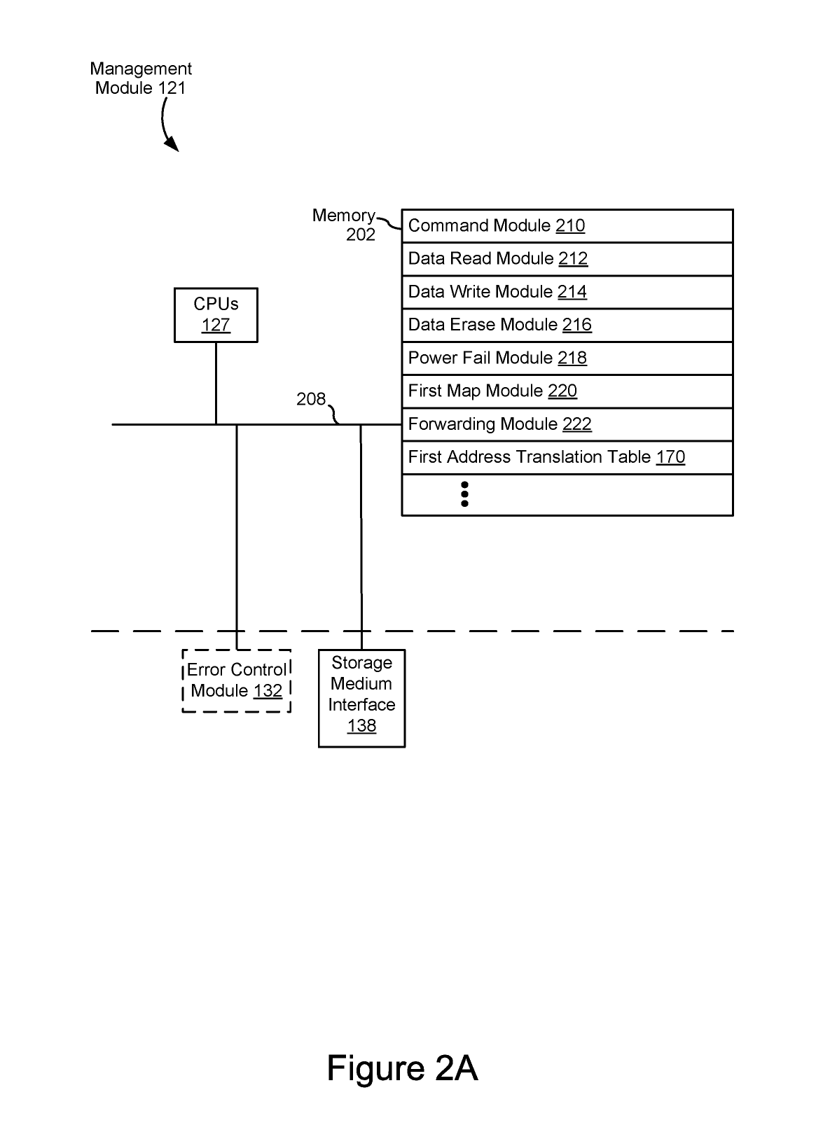

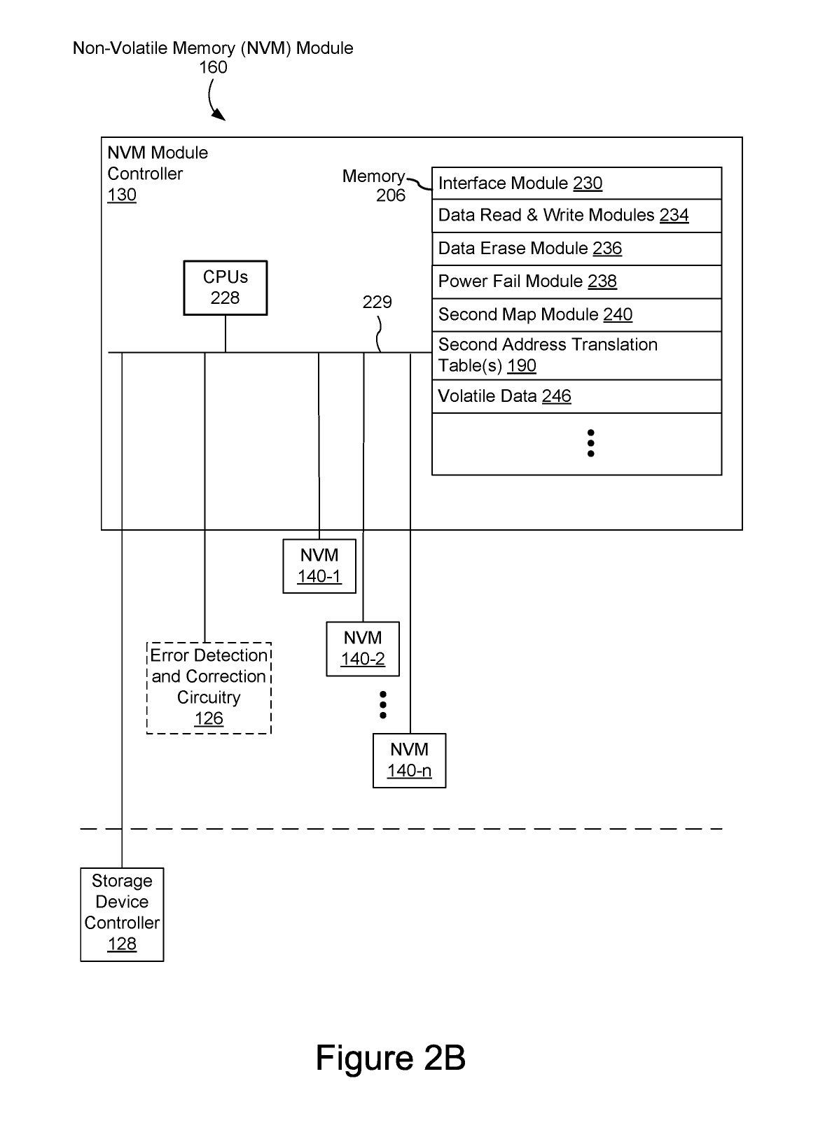

FIG. 2A illustrates a block diagram of a management module 121 in accordance with some embodiments. Management module 121 typically includes: one or more processing units 127 (sometimes herein called CPUs, hardware processors, processors, microprocessors or microcontrollers) for executing modules, programs and/or instructions stored in memory 202 and thereby performing processing operations. Management module 121 also includes memory 202 (sometimes herein called controller memory), and one or more communication buses 208 for interconnecting these components. Communication buses 208 optionally include circuitry (sometimes called a chipset) that interconnects and controls communications between system components. Management module 121 is coupled by communication buses 208 to storage medium interface 138 and, optionally, to error control module 132 if storage device controller 128 includes an error control module 132. Memory 202 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 202 optionally includes one or more storage devices remotely located from the CPU(s) 127. Memory 202, or alternatively the non-volatile memory device(s) within memory 202, comprises a non-transitory computer readable storage medium. In some embodiments, memory 202, or the non-transitory computer readable storage medium of memory 202, stores the following programs, modules, and data structures, or a subset or superset thereof:
command module (sometimes called an interface module) 210 for receiving or accessing a host command specifying an operation to be performed and a logical address corresponding to a portion of non-volatile memory within the storage device;
data read module 212 for reading data from non-volatile memory (e.g., NVM devices 140, 142) in NVM modules 160 (FIG. 1);
data write module 214 for writing data to non-volatile memory (e.g., NVM devices 140, 142) in NVM modules 160;
data erase module 216 for erasing data in non-volatile memory (e.g., NVM devices 140, 142) in NVM modules 160;
power fail module 218 for detecting a power failure condition on the storage device (e.g., storage device 120, FIG. 1) and triggering storage of data in volatile memory to non-volatile memory, and optionally working with power fail module 238 in one or more of the NVM modules 160 (FIG. 1);
first map module 220 for mapping a logical address (or a portion of logical address) specified by a host command to a partial physical address corresponding to a coarse memory portion within NVM modules 160 (FIG. 1), using first address translation table 170;
a forwarding module 222 for forwarding a command, corresponding to the host command, to an NVM module of the plurality of NVM modules identified in accordance with the aforementioned partial physical address, produced by first map module 220; and
first address translation table 170 for storing address mapping information indicating mappings of respective logical address portions (e.g., a predefined subset of the most significant bits of respective logical addresses) to partial physical addresses, each partial physical address corresponding to a coarse memory portion in NVM modules 160, FIG. 1.

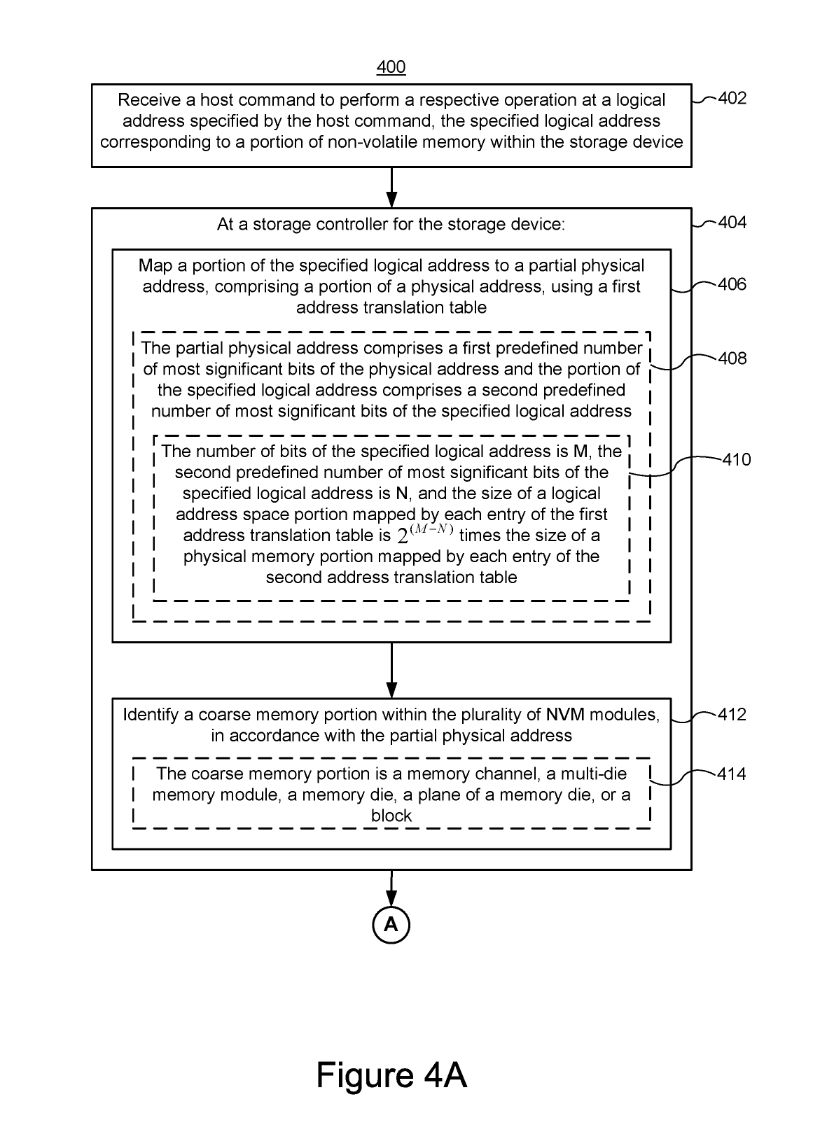

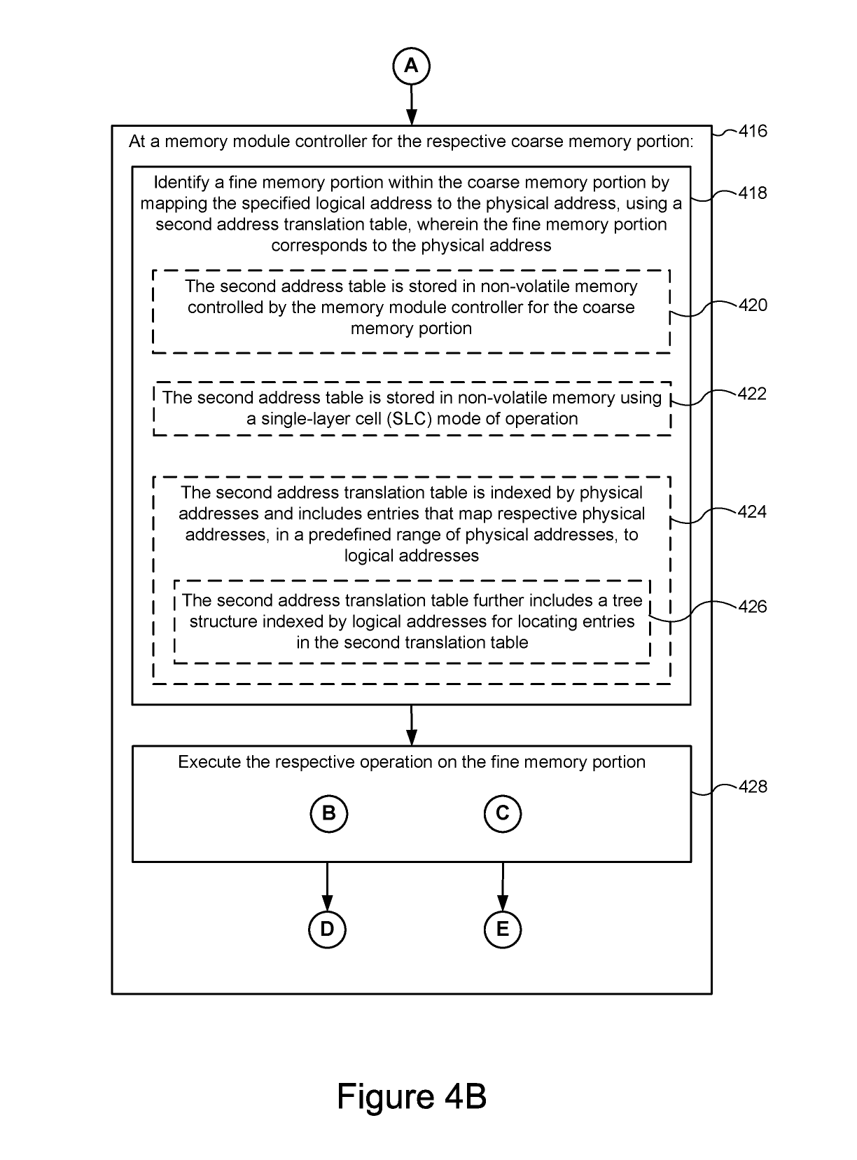

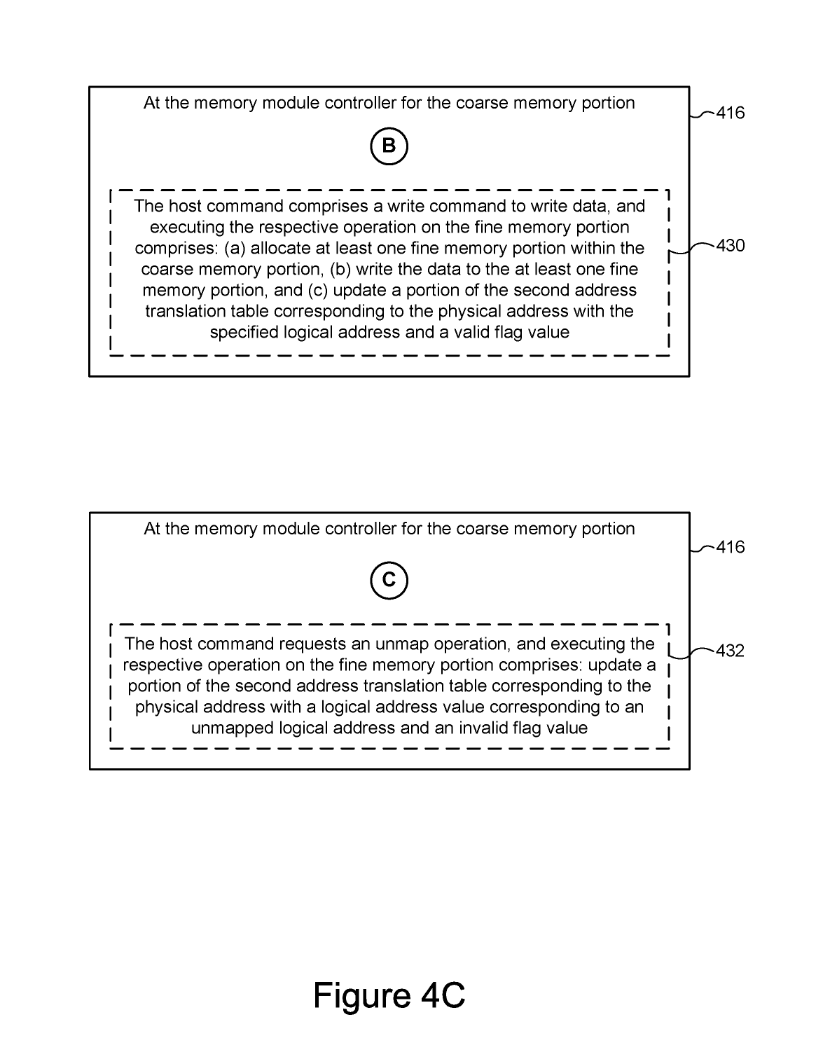

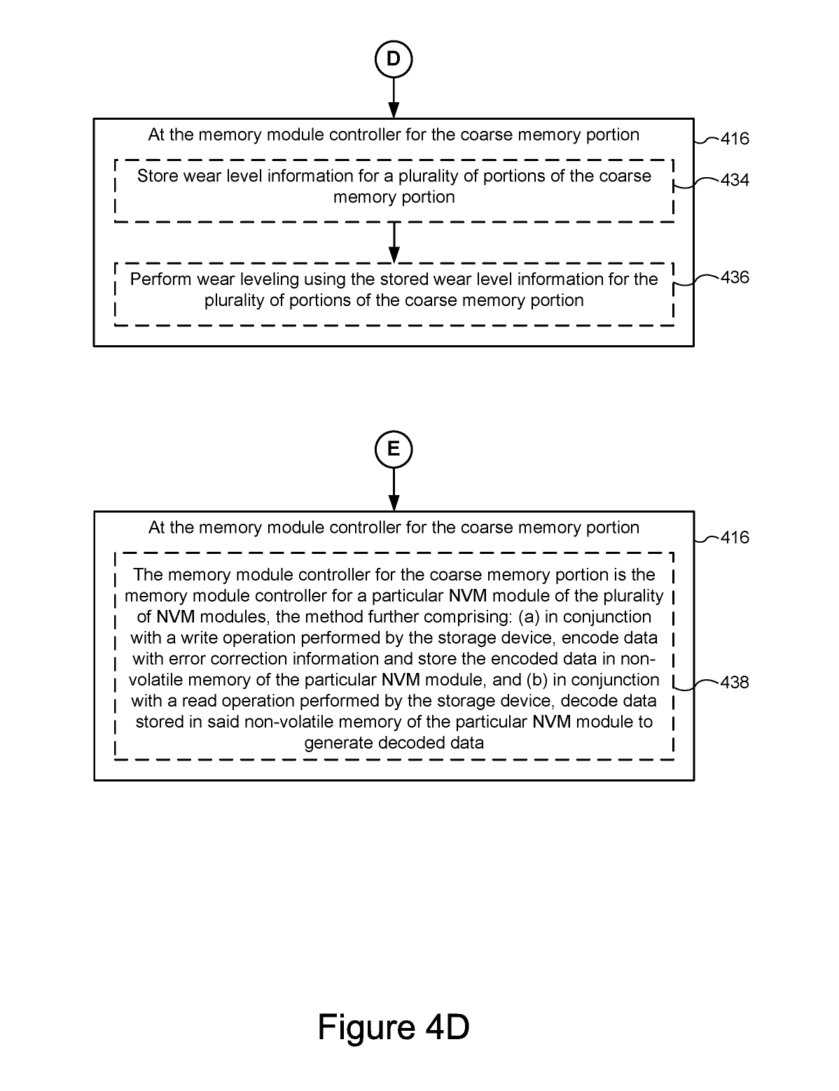

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 202 may store a subset of the modules and data structures identified above. Furthermore, memory 202 may store additional modules and data structures not described above. In some embodiments, the programs, modules, and data structures stored in memory 202, or the non-transitory computer readable storage medium of memory 202, provide instructions for implementing any of the methods described below with reference to FIGS. 4A-4D. Stated another way, the programs or modules stored in memory 202, when executed by the one or more processors 127, cause storage device 120 to perform any of the methods described below with reference to FIGS. 4A-4D.

Although FIG. 2A shows a management module 121, FIG. 2A is intended more as functional description of the various features which may be present in a management module than as a structural schematic of the embodiments described herein. In practice, and as recognized by those of ordinary skill in the art, the programs, modules, and data structures shown separately could be combined and some programs, modules, and data structures could be separated.

FIG. 2B is a block diagram illustrating an implementation of a NVM module 160, in accordance with some embodiments. NVM module 160 includes an NVM module controller 130, which in turn includes one or more processing units 228 (sometimes called CPUs, processors, hardware processors, microprocessors or microcontrollers) for executing modules, programs and/or instructions stored in memory 206 (sometimes herein called controller memory) and thereby performing processing operations; and memory 206. NVM module 160 further includes NVM devices 140 (or NVM devices 142), and one or more communication buses 229 for interconnecting these components of NVM module 160. Communication buses 229 optionally include circuitry (sometimes called a chipset) that interconnects and controls communications between system components. NVM module 160 is also coupled to storage device controller 128, for example to receive read and write commands and partial physical addresses that correspond to coarse memory portions in NVM module 160.

Memory 206 includes high-speed random access memory, such as DRAM, SRAM, DDR RAM or other random access solid state memory devices, and may include NVM, such as one or more magnetic disk storage devices, optical disk storage devices, flash memory devices, or other non-volatile solid state storage devices. Memory 206 optionally includes one or more storage devices remotely located from NVM controller 130. Memory 206, or alternately the non-volatile memory device(s) within memory 206, comprises a non-transitory computer readable storage medium. In some embodiments, memory 206, or the computer readable storage medium of memory 206 stores the following programs, modules, and data structures, or a subset thereof:
interface module 230 for communicating with other components, such as storage device controller 128, and error detection and correction circuitry 126;
data read and write modules 234, sometimes collectively called a command execution module, for reading data from and writing data to NVM devices 140;
data erase module 236 for erasing portions of non-volatile memory in NVM devices 140;
power failure module 238 for detecting a power failure condition on the storage device (e.g., storage device 120, FIG. 1) and triggering storage of data in volatile memory to non-volatile memory;
second map module 240 for mapping a logical address specified by a host command to a physical address corresponding to a fine memory portion within NVM modules 160 (FIG. 1), using second address translation table 190;
one or more second address translation tables 190, each for storing address mapping information indicating mappings of respective logical addresses (or alternatively, a predefined subset of the least significant bits of respective logical addresses) to physical addresses, each physical address corresponding to a fine memory portion in NVM modules 160, FIG. 1; and
volatile data 246, such as health information, memory operation parameters, cached portions or a second address translation table or a cached copy of a second address translation table.

As noted above, in some embodiments, each NVM module 160 has a single second address translation table 190 for handling the mapping of logical addresses into physical address for all non-volatile memory in the NVM module 160. In some other embodiments, each NVM module has multiple second address translation tables 190, each of which is used to handle the mapping of logical addresses into physical address for one coarse memory portion, or multiple coarse memory portions, of the non-volatile memory in the NVM module 160. Various data structures for implementing table(s) 190 are described above with reference to FIG. 1.

In some embodiments, one or more second address translation tables 190, or a portion of a second address translation table 190, depending on the implementation, is stored in volatile memory (e.g., cache memory 180, FIG. 1) to facilitate address translations and updates to the one or more second address translation tables 190 during operation of the NVM module controller 130. In some such embodiments, updates to any of the second address translation tables 190 (e.g., updates caused by write operations, unmap operations or garbage collection operations) are stored to non-volatile memory by power fail module 238 in response to detection of a power fail condition. or portions thereof stored in volatile memory. Alternatively, any of the second address translation tables 190 or portions thereof stored in volatile memory at the time a power fail condition is detected are stored to non-volatile memory by power fail module 238.

Each of the above identified elements may be stored in one or more of the previously mentioned storage devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above. In some embodiments, the programs, modules, and data structures stored in memory 206, or the computer readable storage medium of memory 206, include instructions for implementing respective operations in the methods described below with reference to FIGS. 4A-4D.

Although FIG. 2B shows NVM module 160 in accordance with some embodiments, FIG. 2B is intended more as a functional description of the various features which may be present in a NVM module than as a structural schematic of the embodiments described herein. In practice, and as recognized by those of ordinary skill in the art, items shown separately could be combined and some items could be separated. Further, the above description of NVM module 160 applies to each of the NVM modules 160-1 to 160-m of storage device 120 (FIG. 1).

FIGS. 3A-3B illustrate various logical to physical memory address translation tables, in accordance with some embodiments.

Table 300 is an example of a single-level logical-to-physical (sometimes abbreviated as L2P) address translation table, which is different from the multi-level address translation tables used in the embodiments described herein. Table 300 is typically indexed by and sorted by logical address. Table 300 is an example of a logical-to-physical address translation table in which logical addresses are mapped to 32-bit physical addresses. In other words, in this example, there are 32-bits per physical address (as counted in row 310). Each row (sometimes called each entry), 304, 306, 308 of table 300 maps a logical address to a physical address. The physical addresses are used by the storage device to locate a specific unit or memory, typically a page, when performing read and write operations. In some embodiments, table 300 is indexed by the logical addresses, in which case, the row corresponding to a particular logical address is determined by the position of the row in table 300, or equivalently by the offset of the row from the beginning of table 300. In some such implementations, the logical address for each row of table 300 is not stored in the row, since that information is already available from the position or offset of the row.

In some embodiments, the physical addresses used when reading data from and writing data to a storage device have more than 32 bits, for example 40 or 48 bits, which enables the storage device to have a larger physical address space and to store more data. However, the logical-to-physical address translation table needed to address such a large physical address space is typically so large that using and managing the address translation table is a significant problem. In the embodiments described herein, that problem is ameliorated by providing two levels of address translation tables, all of which are much smaller, individually, than a single-level address translation table for the same physical address space.

Table 312 is an example of a first address translation table 170, while tables 324 and 338 are examples of second address translation tables 190. For example, table 312 is a logical-to-physical address translation table that maps portions of logical addresses to partial physical addresses. The logical addresses are typically specified by host commands, and are typically converted to a portion of the logical address by selecting a predefined number, N, of the most significant bits (e.g., the 30 most significant bits of a 32 logical address) of the M bits in each specified logical address, where N and M are positive integers and N is smaller than M. For example, rows 316, 318, and 320 of table 312 contain entries that map predefined portion of respective logical addresses to 9-bit partial physical addresses (as counted in row 322).

For ease of discussion, each specified logical address is said to correspond to a lower-level page, e.g., a page having a size of 4K bytes, while the portion of each specified logical address corresponds to a top-level page, e.g., a page having a size of 16K bytes, which is larger than the lower-level page.

Each partial physical address in table 312 has a predetermined number (e.g., nine) of most significant bits of the physical address corresponding to a specified logical address, and corresponds to a “coarse” memory portion, such as a flash memory die or other non-volatile or persistent memory die. In other examples, each coarse memory portion corresponds to a “plane” of a non-volatile memory die, or a group of non-volatile memory die, a multi-die memory module, or a memory channel.

Because table 312, which is an example of first address translation table 170 (FIG. 1), maps a portion of a specified logical address instead of the entire logical address, it has fewer entries than a complete, single level address translation table like table 300 (e.g., table 170 has 25% as many entries as a complete, single level address translation table when the logical address portion has 2 fewer bits than the corresponding full logical address), and because table 312 maps the portion of the logical address to a partial physical address, which is smaller than the corresponding entire physical address, each of the entries of table 312 is smaller than corresponding entries in a complete, single level address translation table 300. As a result, the first address translation table 170 managed by storage device controller 128 is smaller in size than traditional flash translation layer address translation tables for a given number of distinct logical addresses, and can be more easily scaled to handler larger capacity storage devices.

Tables 324 and 338 are examples of second address translation tables 190, in which physical addresses are mapped to logical addresses. In some embodiments, the physical addresses and logical addresses mapped by second address translation tables 190 are complete physical and logical addresses, with all address bits.

In this example, each second address translation table 324, 328 maps the physical addresses of one coarse memory portion to the corresponding logical addresses. Entries for physical addresses not mapped to logical addresses indicate that the corresponding physical addresses are unmapped. Further, the number of entries in each second address translation table 190 corresponds to the number of distinct physical addresses in a coarse memory portion. Alternatively, in some embodiments, each second address translation space maps the physical addresses for two or more coarse memory portions within a single NVM module 160.

While each second address translation table 190 is relatively small compared with a single-level address translation table, such as table 300 (FIG. 3A), it could still take a significant amount of time to linearly search an entire such second address translation table 190 to find a specified logical address. For this reason, in some embodiments, each second address translation table 190 includes a B-tree or other tree structure that maps the logical addresses in that second address translation table 190 to either the corresponding entry in second address translation table 190, or equivalently to the corresponding physical address or physical address offset within the coarse memory portion mapped by that second address translation table 190.

Tables 324 and 338, in this example, each reside on distinct NVM modules (e.g., NVM modules 160, FIG. 1) and are managed by distinct NVM module controllers 130 (FIG. 1). Thus, address mapping is partially handled by NVM module controllers 130, which reduces the address mapping workload of storage device controller 128.

Further, as the size of flash memory increases, flash memory performance drops due to increasing logical-to-physical addressing table size. One possible approach to reducing table size is to increase logical page size, so that less entries are stored in the translation table and hence cache hit rate improves. However, increasing logical page size may increase write amplification. Tables 312, 324, and 338 illustrate the address translation scheme in which the logical page size is increased in the top-level address translation table (e.g., first address translation table 170, FIG. 1), without increasing write amplification, because the logical page size in the second level address translation tables is maintained at its default size (corresponding to the memory space size for the logical addresses specified by received host commands). For example, entries stored in first address translation table 170 (FIG. 1) managed by storage device controller 128 can correspond to 16 KB top-level pages, while entries stored in second address translation tables 190 (FIG. 1) managed by NVM module controllers 130 can correspond to 4 KB lower-level pages.

To provide two page sizes, a predefined number of most significant bits of the specified logical addresses are mapped by entries in first address translation table 170 (FIG. 1) to partial physical addresses, while entire logical addresses are stored in entries of second address translation tables 190 (FIG. 1). In some embodiments, where the number of bits of the specified logical address is M, and the predefined number of most significant bits of the specified logical address is N (e.g., in row 316, the logical address 1045 is obtained by removing the least two significant bits of 4182), the size of a logical address space portion (i.e. a top-level page) mapped by each entry of the first address translation table is 2^{(M-N)} times the size of a physical memory portion (i.e., a lower-level page) mapped by each entry of the second address translation table. For example, entries stored in tables 324 and 338 include logical addresses, such as 4181 in row 330 and 4182 in row 332 (FIG. 3B), while each entry stored in table 312 maps a portion of a logical address, such as 1045 in row 316, obtained by removing the two least significant bits of 4180 (row 336), 4181 (row 330), 4182 (row 332), or 4183 (row 334). As a result, the size (e.g., 16 KB) of a logical address space portion mapped by each row of table 312 is 2² (i.e., 4) times the size (e.g., 4 KB) of the physical memory portion mapped by each entry in table 324.

The tiered address translation scheme described above is not limited to two tiers of address translation. As storage systems and storage devices increase in capacity, the need for intermediate modules or structures within storage devices will result in increasingly longer physical addresses. In some embodiments, additional tiers of address translation will be performed by such intermediate modules or structures.

FIGS. 4A-4D illustrate a flowchart representation of method 400 of operating a storage device having a plurality of NVM modules, in accordance with some embodiments. At least in some implementations, method 400 is performed by a storage device (e.g., storage device 120, FIG. 1A) or one or more components of the storage device (e.g., NVM controllers 130 and/or storage device controller 128, FIG. 1B). In some embodiments, method 400 is governed by instructions that are stored in a non-transitory computer readable storage medium and that are executed by one or more processors of a device, such as processors 228 in the one or more NVM controllers 130 of NVM modules 160 and one or more processors 127 in storage device controller 128 (see FIGS. 1, 2A and 2B).

The method includes receiving (402), or alternatively accessing (e.g., from a command queue), a host command specifying an operation (e.g., reading, writing, unmapping) to be performed at a logical address corresponding to a portion of non-volatile memory within the storage device. For example, a storage device (e.g., storage device 120, FIG. 1A) receives or accesses a host command to write data to a block of memory (e.g., a block of memory on one of NVM devices 140, 142). In some embodiments, or in some circumstances, the portion of non-volatile memory is an erase block or a portion of an erase block, such as a page. In some embodiments, NVM devices are, or include, one or more flash memory devices.

The method includes, at a storage controller for the storage device (404) (e.g., storage device controller 128, FIG. 1), mapping (406) a portion of the specified logical address to a partial physical address, which is a portion of a physical address (i.e., a complete physical address), using a first address translation table. For example, referring to FIG. 3A, table 312 shows a logical-to-physical address translation table that resides in storage device controller 128 (e.g., first address translation table 170, FIG. 1). In this example in FIG. 3A, the host command is to write to a page (or sub-page) having a logical address of 4180. Row 316 of table 312 is an entry for a logical address portion equal to 1045, which corresponds to logical addresses 4180-4183. The entry in row 316 maps that logical address portion to a partial physical address (or first subset of a physical address), indicating memory channel 3, chip select 0, die 2.

In some embodiments, the partial physical address includes (408) a first predefined number of most significant bits of the physical address and the portion of the specified logical address comprises a second predefined number of most significant bits of the specified logical address. For example, in logical-to-physical address translation table 312 (FIG. 3A), the partial physical address indicating memory channel 3, chip select 0, die 2 has the first 9 bits of the 32-bit physical address shown in row 304 of table 300; and the logical address portion that equals to 1045 in row 316 of table 312 is obtained by removing the two least significant bits of logical address of 4180 (or alternatively logical address 4181, 4182, or 4183).

In some embodiments, the number of bits of the specified logical address is (410) M, the second predefined number of most significant bits of the specified logical address is N, and the size of a logical address space portion mapped by each entry of the first address translation table is 2^{M-N} times the size of a physical memory portion mapped by each entry of the second address translation table. For example, in table 324 (FIG. 3B), the number of bits of logical address 4180 is M, and 4180 is mapped to physical address PA x, which identifies a physical memory portion of size 4 KB. In table 312 (FIG. 3A), the number of bits of logical address portion 1045 is N, and 1045 is obtained by removing the two least significant bits of 4180, such that M-N is 2. Therefore, in this example, 2^{M-N}=4, and the size of logical address space portion mapped by entry 1045 is 16 KB, which is four times the size of the physical memory portion mapped by PA x in table 324 (FIG. 3B).

Following the mapping (406), the method further includes, at the storage controller for the storage device (404) (e.g., storage device controller 128, FIG. 1), identifying (412) a coarse memory portion within the plurality of NVM modules, in accordance with the partial physical address. For example, in accordance with the partial physical address indicating memory channel 3, chip select 0, die 2, storage device controller 128 (FIG. 1) identifies die 2 as a coarse memory portion. In this example, the coarse memory portion is a die. In some embodiments, the coarse memory portion is (414) a memory channel, a multi-die memory module, a memory die, a plane of a memory die, or a block.

The above steps are performed at the storage controller (e.g., storage device controller 128, FIG. 1), at a memory module controller (416) (e.g., NVM module controller 130, FIG. 1), the method further includes identifying (418) a fine memory portion within the coarse memory portion by mapping the specified logical address to the physical address, using a second address translation table (e.g., second address translation table 190, FIG. 1). In some embodiments, the fine memory portion corresponds to the physical address. For example, within a coarse memory portion (e.g., a die), a NVM device is divided into a number of addressable and individually selectable blocks, which can be further divided into a number of pages, for example, 64 pages, 128 pages, 256 pages or another suitable number of pages. Continuing the example discussed above, a fine memory portion (e.g., a page) within die 2 that corresponds to physical address PA x is identified by mapping the specified logical address 4180 to physical address PA x in second address translation table 324.

In some embodiments, the second address table is stored (420) in non-volatile memory controlled by the memory module controller for the coarse memory portion, and in some embodiments, the second address table is stored (422) in non-volatile memory using a single-layer cell (SLC) mode of operation. The second address table (e.g., second address translation table 190, FIG. 1) is typically stored in non-volatile memory (e.g., in a respective NVM module 160, FIG. 1) controlled by the memory module controller (e.g., NVM module controller 130, FIG. 1) for the coarse memory portion, such as a flash memory die, but is not necessarily stored in the part of the physical address space to which logical addresses can be mapped. For example, in some implementations, the second address table is stored in a portion of non-volatile memory reserved for storing address translation tables and other memory management information.

In some embodiments, the second address translation table is indexed (424) by physical addresses and includes entries that map respective physical addresses, in a predefined range of physical addresses, to logical addresses. In some embodiments, the second address translation table further includes (426) a tree structure indexed by logical addresses for locating entries in the second translation table. The tree is, for example, a B-tree for locating entries in the second address translation table, and maps logical addresses, which have been mapped to physical addresses in the predefined range of physical addresses, to entries in the second address translation table. The tree structure provides a fast mechanism for locating the entry in the second address translation table corresponding to a specified logical address. Thus, for example, when data storage system 100 (see FIG. 1) is responding to a read command from a host device 110, the storage device controller maps the logical address specified by the read command to a coarse memory portion, and the tree structure is then used to efficiently locate a specific entry in the second address translation table corresponding to that coarse memory portion. The logical address is then mapped to a physical address using physical address information in that entry of the second address translation table.

Following the identifying (418), the method further includes, at the memory module controller (416) (e.g., the respective NVM module controller 130, FIG. 1), executing (428) the respective operation (e.g., reading, writing, unmapping) on the fine memory portion. During a write operation, in accordance with some embodiments, the host command comprises (430) a write command to write data, and executing the respective operation on the fine memory portion comprises: (a) allocating at least one fine memory portion (e.g., at least one page) within the coarse memory portion (e.g., a die), (b) writing the data to the at least one fine memory portion, and (c) updating a portion of the second address translation table corresponding to the physical address with the specified logical address and a valid flag value (e.g., changing the valid flag value to “valid”). During an unmap operation, in accordance with some embodiments, the host command requests (432) an unmap operation, specifying a logical address to be unmapped, and executing the respective operation on the fine memory portion comprises: updating a portion of the second address translation table corresponding to the specified logical address with an invalid flag value (e.g., changing the valid flag value, in the entry corresponding to the specified logical address, to “invalid”). For example, using the tree structure discussed above, the entry of the second address translation table corresponding to the specified logical address is located, and then an invalid flag value is set in that entry.

In some embodiments, at the memory module controller (416) (e.g., NVM module controller 130, FIG. 1), the method further includes storing (434) (e.g., in second address translation table 190, FIG. 1) wear level information for a plurality of portions of the coarse memory portion and performing (436) wear leveling using the stored wear level information for the plurality of portions of the coarse memory portion.

In addition to performing wear leveling by each of the memory controllers for the NVM modules, error correction can also be decentralized in accordance with some embodiments. In some embodiments, the memory module controller for the coarse memory portion is (438) the memory module controller for a particular NVM module of the plurality of NVM modules, and the method further includes: at the memory module controller for the particular NVM module, (a) in conjunction with a write operation performed by the storage device, encoding data with error correction information and stores the encoded data in non-volatile memory of the particular NVM module, and (b) in conjunction with a read operation performed by the storage device, decoding data stored in said non-volatile memory of the particular NVM module to generate decoded data. Thus, the memory module controller for the particular NVM module performs the data encoding operation, locally at the NVM module, in conjunction with performing the write operation (for data written to non-volatile memory within the NVM module), and also performs the data decoding operations, locally at the NVM module, in conjunction with performing the read operation (for data read from non-volatile memory within the NVM module).

For example, referring to FIG. 1, during a write operation, data from host interface 122 are sent to management module 121. After the storage device controller 128 identifies a coarse memory portion within NVM modules 160 (e.g., a memory channel, a multi-die memory module, a memory die, a plane of a memory die, or a block), the data are sent to a NVM module controller 130 for the coarse memory portion via storage medium interface 138. The NVM module controller for the coarse memory portion is also the memory module controller 130 for a particular NVM module (e.g., NVM module 160). Upon receiving the data, the NVM module controller 130 encodes data with error correction information and stores the encoded data in non-volatile memory of the particular NVM module (e.g., NVM 140, 142).

In another example, during a read operation, after the storage device controller 128 identifies the coarse memory portion, a NVM module controller 130 for the coarse memory portion, which is also the NVM module controller 130 for a particular NVM module 160, identifies the fine memory portion, retrieves data stored in non-volatile memory (e.g., NVM 140, 142) of the particular NVM module 160 and decodes the retrieved data to generate decoded data. In some embodiments, upon successful decoding at error detection and correction circuitry 126 in the NVM module controller 130, the decoded data is provided to host interface 122, where the decoded data is made available to computer system 110. In some implementations, if the decoding is not successful, NVM module controller 130 or error detection and correction circuitry 126 may resort to a number of remedial actions or provide an indication of an irresolvable error condition.

It will be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

What is claimed is:

1. A method for operating a storage device having a plurality of NVM modules, comprising:
receiving a host command to perform a respective operation at a logical address specified by the host command, the specified logical address corresponding to a portion of non-volatile memory within the storage device;
at a storage controller for the storage device:
mapping a portion of the specified logical address to a partial physical address, comprising a portion of a physical address, using a first address translation table;
identifying a coarse memory portion within the plurality of NVM modules, in accordance with the partial physical address;
at a memory module controller for the coarse memory portion:
identifying a fine memory portion within the coarse memory portion by mapping the specified logical address to the physical address, using a second address translation table, wherein the fine memory portion corresponds to the physical address; and
executing the respective operation on the fine memory portion.

2. The method of claim 1, wherein the host command comprises a write command to write data, and executing the respective operation on the fine memory portion comprises:
at the memory module controller for the coarse memory portion:
allocating at least one fine memory portion within the coarse memory portion;
writing the data to the at least one fine memory portion; and
updating a portion of the second address translation table corresponding to the physical address with the specified logical address and a valid flag value.

3. The method of claim 1, wherein the host command requests an unmap operation and specifies a logical address to be unmapped, and executing the respective operation on the fine memory portion comprises:
at the memory module controller for the coarse memory portion:
updating a portion of the second address translation table corresponding to the specified logical address with an invalid flag value.

4. The method of claim 1, wherein the second address table is stored in non-volatile memory controlled by the memory module controller for the coarse memory portion.

5. The method of claim 1, wherein the second address table is stored in non-volatile memory using a single-layer cell (SLC) mode of operation.

6. The method of claim 1, wherein the partial physical address comprises a first predefined number of most significant bits of the physical address and the portion of the specified logical address comprises a second predefined number of most significant bits of the specified logical address.

7. The method of claim 6, wherein the number of bits of the specified logical address is M, the second predefined number of most significant bits of the specified logical address is N, and the size of a logical address space portion mapped by each entry of the first address translation table is 2^{(M-N)} times the size of a physical memory portion mapped by each entry of the second address translation table.

8. The method of claim 1, wherein the coarse memory portion is a memory channel, a multi-die memory module, a memory die, a plane of a memory die, or a block.

9. The method of claim 1, the method further comprising:
at the memory module controller for the coarse memory portion:
storing wear level information for a plurality of portions of the coarse memory portion; and
performing wear leveling using the stored wear level information for the plurality of portions of the coarse memory portion.

10. The method of claim 1, wherein the memory module controller for the coarse memory portion is the memory module controller for a particular NVM module of the plurality of NVM modules, the method further comprising:
at the memory module controller for the particular NVM module:
in conjunction with a write operation performed by the storage device, encoding data with error correction information and storing the encoded data in non-volatile memory of the particular NVM module; and
in conjunction with a read operation performed by the storage device, decoding data stored in said non-volatile memory of the particular NVM module to generate decoded data.

11. The method of claim 1, wherein the second address translation table is indexed by physical addresses and includes entries that map respective physical addresses, in a predefined range of physical addresses, to logical addresses.

12. The method of claim 11, wherein the second address translation table further includes a tree structure indexed by logical addresses for locating entries in the second translation table.

13. A storage device, comprising:
an interface for coupling the storage device to a host system;
a plurality of NVM modules;
a storage controller having one or more hardware processors, the storage controller configured to:
receive a host command specifying a respective operation to be performed at a logical address specified by the host command, the specified logical address corresponding to a portion of non-volatile memory within the storage device;
map a portion of the specified logical address to a partial physical address, comprising a portion of a physical address, using a first address translation table; and
identify a coarse memory portion within the plurality of NVM modules, in accordance with the partial physical address; and
a memory module controller for the identified coarse memory portion, the memory module controller having one or more hardware processors and configured to:
identify a fine memory portion within the coarse memory portion by mapping the specified logical address to the physical address, using a second address translation table, wherein the fine memory portion corresponds to the physical address; and
execute the respective operation on the fine memory portion.

14. The storage device of claim 13, wherein
the storage controller includes a first map module, for execution by the one or more hardware processors of the storage controller, to map the portion of the specified logical address to the partial physical address using the first address translation table, and
the memory module controller includes a second map module, for execution by the one or more hardware processors of the memory module controller, to map the specified logical address to the physical address, using the second address translation table.

15. The storage device of claim 13, wherein the host command comprises a write command to write data, and executing the respective operation on the fine memory portion comprises:
at the memory module controller for the coarse memory portion:
allocating at least one fine memory portion within the coarse memory portion;
writing the data to the at least one fine memory portion; and
updating a portion of the second address translation table corresponding to the physical address with the specified logical address and a valid flag value.

16. The storage device of claim 13, wherein the host command requests an unmap operation and specifies a logical address to be unmapped, and executing the respective operation on the fine memory portion comprises:
at the memory module controller for the coarse memory portion:
updating a portion of the second address translation table corresponding to the specified logical address with an invalid flag value.

17. The storage device of claim 13, wherein the second address table is stored in non-volatile memory controlled by the memory module controller for the coarse memory portion.

18. The storage device of claim 13, wherein the second address table is stored in non-volatile memory using a single-layer cell (SLC) mode of operation.

19. The storage device of claim 13, wherein the partial physical address comprises a first predefined number of most significant bits of the physical address and the portion of the specified logical address comprises a second predefined number of most significant bits of the specified logical address.

20. The storage device of claim 19, wherein the number of bits of the specified logical address is M, the second predefined number of most significant bits of the specified logical address is N, and the size of a logical address space portion mapped by each entry of the first address translation table is 2^{(M-N)} times the size of a physical memory portion mapped by each entry of the second address translation table.

21. A storage device, comprising:
a plurality of NVM modules;
means for coupling the storage device to a host system;
means for controlling operation of the storage device, including:
means for receiving a host command specifying a respective operation to be performed at a logical address specified by the host command, the specified logical address corresponding to a portion of non-volatile memory within the storage device; and
means for mapping a portion of the specified logical address to a partial physical address, comprising a portion of a physical address, using a first address translation table;
wherein a coarse memory portion within a respective NVM module, comprising one of the plurality of NVM modules, corresponds to the partial physical address; and
means for controlling operation of the respective NVM module, including:
means for identifying a fine memory portion within the coarse memory portion by mapping the specified logical address to the physical address, using a second address translation table, wherein the fine memory portion corresponds to the physical address; and
means for executing the respective operation on the fine memory portion.
